(19) United States
(12) Patent Application Publication
(10) Pub. No.: US 2008/0192084 A1
(43) Pub. Date: Aug. 14, 2008

(54) Cleaning device for injet head of large-sized inkjet printer and cleaning module thereof

(75) Inventors: Hsien-Chang Lin, Hsi Chih City (TW); Yu-Ming Yang, Hsi Chih City (TW); Chen-Chien Tsai, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation

(21) Appl. No.: 11/704,385

(22) Filed: Feb. 9, 2007

(51) Int. Cl. B41J 2/165

(52) U.S. Cl. 347/33

(57) ABSTRACT

A cleaning device for an inkjet head of a large-sized inkjet printer and a cleaning module thereof are disposed under the inkjet module of the printer for cleaning the ink of the inkjet head. The cleaning device includes the cleaning module and a base, wherein the cleaning module includes plural brushing seats and a front end of an engaging seat disposed on the brushing seat is provided with a flexible curved rubber scraper. The base is pivoted by the cleaning module therein and the base is provided with a striking device. When the striking device rotates and shifts in a y-shaped sliding groove disposed on the lateral sheet of the base, the cleaning module could be lifted, lowered and horizontally moved in the base to clean the inkjet head.

### FIELD OF THE INVENTION

The present invention is related to a cleaning device for an inkjet head of a large-sized inkjet printer and a cleaning module thereof, and particularly to a cleaning device of which the cleaning module could be lifted, lowered and horizontally moved in the base by the rotation of a striking device. The arrangement of the brushing seat of the cleaning module could clean the inkjet head effectively without harm.

### DESCRIPTION OF THE PRIOR ART

In printing field, the large-sized inkjet printer could print the images to different mediums of various materials and thickness. It could print the products with small amount but numerous sorts immediately through inkjet printing system to save time and procedure of color separation and halftone. The large-sized inkjet printer could complete the printing proceeding rapidly and have more competitiveness.

At present, the inkjet head of the large-sized inkjet printer is apt to be blocked by residual ink and dust to influence the printing quality after printing for a while. Thus, the inner structure of the inkjet printers is provided with an inkjet head service station whose main object and function are to clean inkjet head to maintain printing quality and seal the inkjet head to keep moisture and avoid dry of the inkjet head after use.

However, the large-sized inkjet printer would result in block of inkjet head easily during long-term printing proceeding and have to clean the inkjet head during printing to maintain the printing quality. Thus, the inkjet head should further be wiped by cotton cloth or the residual ink of the inkjet head should be scraped out by scrapers after the cleaning procedure of the inkjet head is completed. But the ink used in these printers usually contains corrosive materials. And if the inkjet head is wiped by cotton cloth by hands, the ink is apt to drop on hands of users and result in injury. In addition, if the residual ink of the inkjet head is cleaned by scrapers, the ink usually remains and attaches on the scrapers after dry. When the scraper is used again to clean, the inkjet head is injured easily. Moreover, the normal scrapers are made of soft rubber material and are apt to be corroded by ink to produce uneven surface. Once the corroded scrapers are used again and would hurt the inkjet head.

In view of this, for improving above disadvantages to clean the inkjet head by a simple cleaning device to protect hands of users from being hurt by ink and repeat using the cleaning device at ease, the inventor had the motive to try and develop the present invention after hard study.

### SUMMARY OF THE INVENTION

The primary object of the present invention is to provide a cleaning device for an inkjet head with simple structure and easy assembly. It can complete the cleaning proceeding of the inkjet head at the same time during printing by lifting, lowering and horizontally shifting the brushing seats to save cleaning time.

The another object of the present invention is to provide a cleaning module for an inkjet head which has a flexible curved rubber scraper on the front end of the brushing seat to reduce the possibility of hurting the inkjet head.

The another object of the present invention is to provide a cleaning module for an inkjet head which has an absorbing layer attached on the flexible curved scraper by an engaging element. The absorbing layer could absorb the residual ink of the inkjet head and achieve the ambition of cleaning the inkjet head.

The another object of the present invention is to provide a cleaning module for an inkjet head which has an absorbing layer attached on the flexible curved scraper by an engaging element. It prevents the surface of the scraper corroded by ink from contacting and injuring the inkjet head and satisfies the environmental requirement by repeating usage of the brushing seat.

To achieve the above objects, the present invention is related to a cleaning device for an inkjet head of a large-sized inkjet printer and a cleaning module thereof, wherein the cleaning module of the inkjet head includes a plurality of brushing seats. The brushing seat includes an engaging seat and a soft rubber scraper. The rubber scraper is fixed on two opposite sides of the engaging seat to form a curved scraping sheet on the front end of the brushing seat.

In practice, the cleaning module is pivoted movably in the cleaning device for the inkjet head. The base disposed on the cleaning device for the inkjet head is disposed of a striking device. One lateral sheet disposed on the base is provided with a y-shaped sliding groove. Thus, the cleaning module could be moved in the y-shaped sliding groove by the striking device and clean the inkjet head by being lifted, lowered and horizontally moved in the base.

### BRIEF DESCRIPTION OF THE DRAWINGS

FIG. 1 is an exploded perspective view showing the embodiment of cleaning module of the inkjet head of the large-sized inkjet printer in accordance with the present invention;

FIG. 2 is a perspective view showing the embodiment of the cleaning device for the inkjet head of the large-sized inkjet printer in accordance with the present invention;

FIG. 3A is a schematic sectional view of the cleaning module in lying condition according to FIG. 2;

FIG. 3B is a schematic sectional view of the cleaning module in rising condition according to FIG. 2; and

FIG. 4 is a sectional view showing the condition of cleaning inkjet head of the embodiment of FIG. 2.

### DETAILED DESCRIPTION OF THE PREFERRED EMBODIMENT

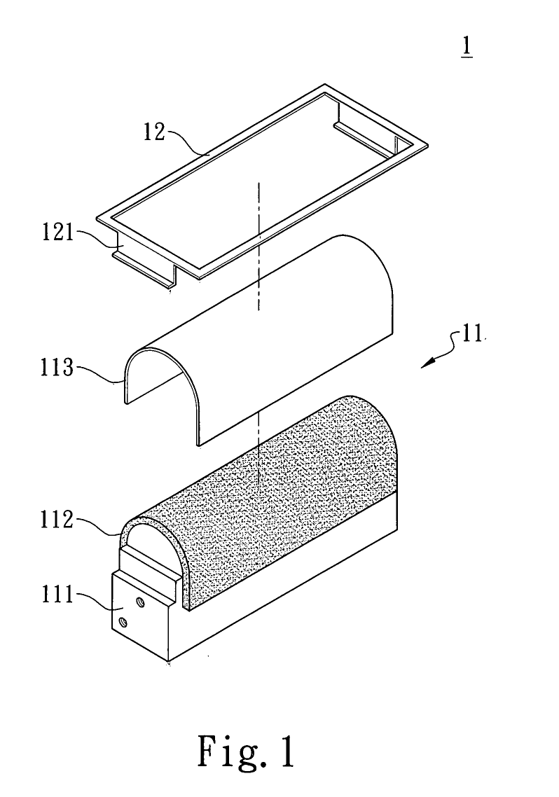

Referring to FIG. 1, the cleaning module 1 of the present invention includes a plurality of brushing seats 11.

The brushing seats 11 includes an engaging seat 111, a soft rubber scraper 112 and an absorbing layer 113, wherein the rubber scraper 112 is fixed on two opposite sides of the engaging seat 111 to make the scraper 112 flexible and curved at the front end of the brushing seat 11. The absorbing layer 113 is disposed above the curved scraper 112 of the front end of the brushing seat 11. And the absorbing layer 113 is fixed on the engaging seat 111 by an engaging element 12.

The absorbing layer 113 is made of cotton cloth. The engaging element 12 is a hollow frame. And two opposite sides of the frame are provided with a coupling sheet 121 respectively to render the cotton cloth be clamped on the engaging seat 111 by the hollow frame on the lateral sides of the curved scraper 112.

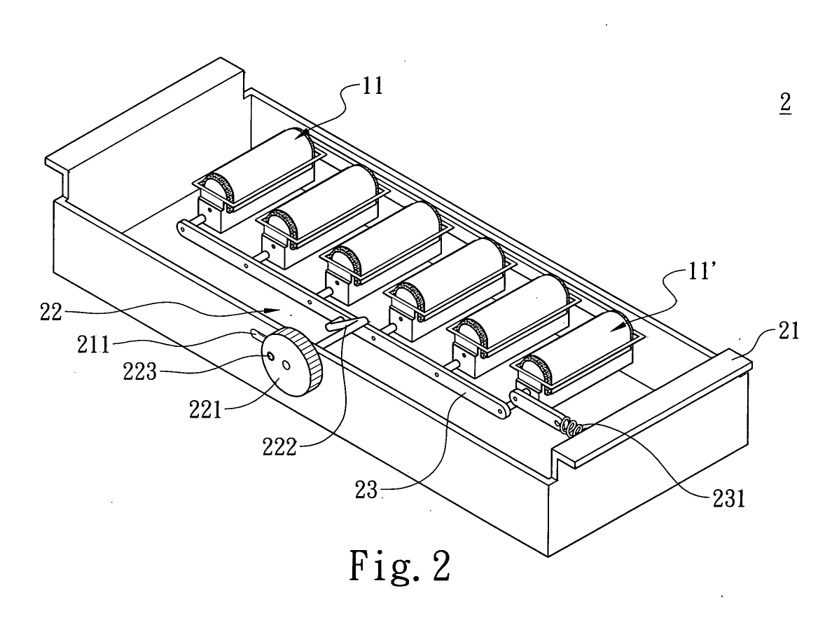

Referring to FIG.2, it is an embodiment of a cleaning device 2 for an inkjet head and the cleaning module 1 thereof of the present invention.

The scraper 112 is made of soft rubber material. And the flexible scraper 112 is in the shape of arc to buffer the strength applied by the brushing seat on the inkjet head to reduce the damage of brushing the inkjet head and to prevent from injuring the inkjet head caused by relative motion during cleaning the inkjet head (not shown in figures).

Moreover, the surface of the cotton cloth is a rough surface so that dust on the inkjet head or dried ink is apt to attach to the cotton cloth. The cotton cloth also could absorb the residual ink on the inkjet head. Thus, the cleaning effect of the brushing seat 11 with the cotton cloth is better than that of using single curved scraper 112.

The cleaning module 1 is pivoted in the cleaning device 2 movably. The cleaning device 2 includes a base 21 which is disposed of a striking device 22 and one lateral sheet of the base 21 is provided with a y-shaped sliding groove 211. The striking device 22 includes a handle 221 and a connecting rod 23, wherein the connecting rod 23 is connected to one end of each brushing seat 11 to swing all brushing seats 11 at the same time and in the same way. The handle 221 is pivoted in the y-shaped sliding groove 211. The end of the shaft of the handle 221 is provided with a proper bending section 222. The handle 221 could connect the connecting rod 23 by the bending section 222 to surely move the cleaning module 1 up and down.

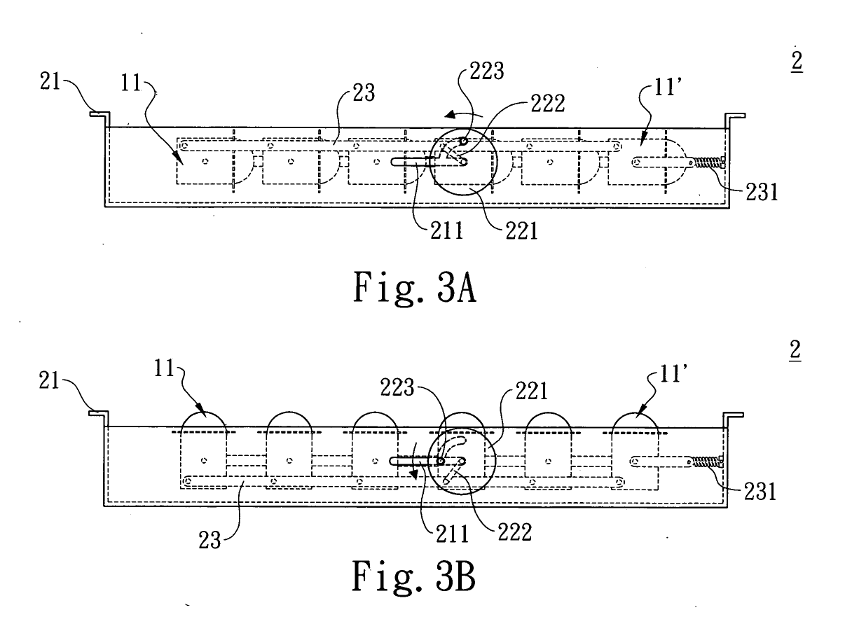

In practice, the cleaning module 1 is assembled under an inkjet module 3 of a large-sized inkjet printer firstly. Meanwhile, the cleaning device 11 lies horizontally in the base 21 (as shown in FIG. 3A) and the brushing seats 11 are horizontal to the arranging direction of the inkjet head (not shown in figures). A restricting element 223 disposed on the handle 221 is located at the short track of the y-shaped sliding groove and the shaft disposed on the handle 221 is located at the long track of the y-shaped sliding groove.

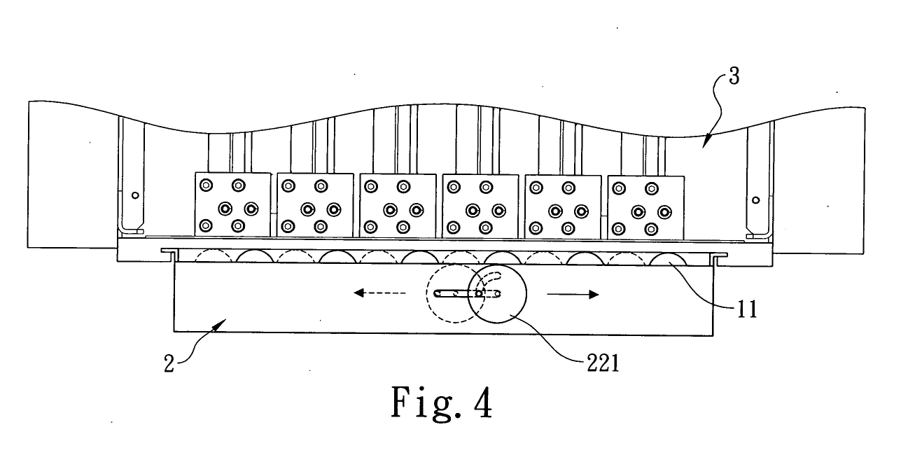

For cleaning the inkjet head, the user has to rotate the handle 221 in the counterclockwise direction to slide the restricting element 223 of the handle 221 into the long track of the y-shaped sliding groove 211. Meanwhile, the cleaning module 1 would swing in the curved shape and be lifted up as upright condition (as shown in FIG. 3B) to render each brushing seat 11 of the cleaning module 1 contact each inkjet head exactly(as shown in FIG. 4). And then the handle 221 is moved back and forth in the y-shaped sliding groove 211 by hand to render the upright cleaning module 1 move in the base 21 horizontally and achieve the ambition of cleaning the inkjet head(as shown in FIG. 4).

Furthermore, one end of the connecting rod 23 is disposed of a proper spring device 231 (as shown in FIG. 2). The spring device 231 is disposed extendedly from the lateral brushing seat 11′ to the base 21 along the moving track of the connecting rod 23. By the procedure of rotating handle 221 and lifting cleaning module 1, the spring device 231 is extended and has a pulling strength. After cleaning motion is ended, the pulling strength of the spring device 231 pulls the cleaning module 1 back automatically to a starting location before displacement to simplify the operation.

Thus, the present invention has following advantages:

1. The present invention with the flexible curved scraper disposed on the cleaning module could prevent from the damage of the inkjet head and the cleaning system caused by wrong rotation direction and exceed force during the user rotating the handle.

2. The present invention with the soft rubber scraper provided with a cotton cloth could achieve the ambition of cleaning the inkjet head by the rough surface of the cloth. And the cotton cloth could absorb the residual ink of the inkjet head to prevent the rubber scraper from being corroded. It is convenient to replace the damaged cotton cloth. The practicability and durability of the cleaning module are improved.

3. In use, the present invention could be disassembled and assembled easily from under the cleaning module and achieve the ambition of cleaning the inkjet head effectively without any electrical device to lower the whole volume and cost of maintenance.

4. The design of the present invention could lift the cleaning module in the base to proper location height to clean the inkjet head back and forth rapidly by hand by a striking device with simple structure. The user could decide the appropriate cleaning time depending on different conditions of accumulated ink to make sure the whole printing quality.

As stated in the above disclosed, the present invention can surely achieve its expected objects to provide a cleaning device for an inkjet head of a large-sized inkjet printer and a cleaning module thereof for cleaning the residual ink of inkjet head effectively without hurt after the procedure of cleaning inkjet head during printing or not printing. The construction of the present invention is simple, easy-assembly and could change the cotton cloth anytime to simplify the proceeding of cleaning inkjet head and improve the efficiency of printing.

What is claimed is:

1. A cleaning module for an inkjet head of a large-sized inkjet printer, comprising a plurality of brushing seats for cleaning the ink of the inkjet head, being characterized in that:
the brushing seat comprises an engaging seat and a flexible rubber scraper, wherein the rubber scraper is fixed on two opposite sides of the engaging seat to form a flexible curved scraping sheet on the front end of the brushing seat.

2. The cleaning module for an inkjet head as claimed in claim 1, wherein the front end of the brushing seat is further provided with an absorbing layer that is fixed on the engaging seat by an engaging element.

3. The cleaning module for an inkjet head as claimed in claim 2, wherein the engaging element is a hollow frame; two opposite sides of the frame are disposed of a coupling sheet respectively for engaging on the engaging seat.

4. The cleaning module for an inkjet head as claimed in claim 2, wherein the absorbing layer is made of cotton cloth.

5. A cleaning device for an inkjet head of a large-sized inkjet printer for being disposed under the inkjet module of the printer to clean the ink of the inkjet head, comprising:
a cleaning module comprising a plurality of brushing seats, wherein a flexible curved rubber scraper is disposed on the front end of an engaging seat that is disposed on the brushing seat; and
a base for being pivoted by the cleaning module therein movably, wherein the base is disposed of a striking device and one lateral sheet disposed on the base is provided with a y-shaped sliding groove; thus, the cleaning module could be lifted, lowered and horizontally moved in the base to clean the inkjet head by moving the striking device in the y-shaped sliding groove.

6. The cleaning device for an inkjet head as claimed in claim 5, wherein the striking device comprises a handle and a connecting rod; the handle is pivoted in the y-shaped sliding groove and connected to the cleaning module by the connecting rod;
shifting the handle in the y-shaped sliding groove moves the cleaning module in the base.

7. The cleaning device for an inkjet head as claimed in claim 6, wherein one end of the connecting rod is further provided with a spring device; the spring device is extendedly disposed to the base along the moving track of the connecting rod; when the cleaning module is lifted to a located position to clean the inkjet head, the spring device is extended and has a pulling strength to pull the cleaning module back automatically to a starting location before displacement.

8. The cleaning device for an inkjet head as claimed in claim 6, wherein the handle is further provided with a projected restricting element to lift and lower the cleaning module in the base when the handle rotates in the y-shaped sliding groove.

9. The cleaning device for an inkjet head as claimed in claim 8, wherein one end of the connecting rod is further provided with a spring device; the spring device is extendedly disposed to the base along the moving track of the connecting rod; when the cleaning module is lifted to a located position to clean the inkjet head, the spring device is extended and has a pulling strength to pull the cleaning module back automatically to a starting location before displacement.

10. The cleaning device for an inkjet head as claimed in claim 5, wherein the front end of the brushing seat is further provided with an absorbing layer that is fixed on the engaging seat by an engaging element.

11. The cleaning device for an inkjet head as claimed in claim 10, wherein the engaging element is a hollow frame; two opposite sides of the frame are disposed of a coupling sheet respectively for engaging on the engaging seat.

12. The cleaning device for an inkjet head as claimed in claim 10, wherein the absorbing layer is made of cotton cloth.
